(19) United States
(12) Patent Application Publication
(10) Pub. No.: US 2026/0369548 A1
(43) Pub. Date: Nov. 19, 2026

(54) FREE-STANDING ELECTRODE FILM FOR DRY ELECTRODE MANUFACTURE

(71) Applicant: LICAP TECHNOLOGIES, INC., Sacramento, CA (US)

(72) Inventors: Linda Zhong, Sacramento, CA (US); Martin Zea, Sacramento, CA (US)

(21) Appl. No.: 19/745,401

(22) Filed: Jul. 17, 2026

Related U.S. Application Data
(62) Division of application No. 17/835,205, filed on Jun. 8, 2022.

(51) Int. Cl. H01M 4/04; H01M 4/02; H01M 10/0585

(52) U.S. Cl. CPC H01M 4/0435; H01M 10/0585; H01M 2004/021

(57) ABSTRACT

An apparatus for manufacturing an electrode for an energy storage device includes at least one laminator for simultaneously laminating two free-standing electrode films on opposite sides of a current collector and a pair of mill lines operable to produce, respectively, the two films and to feed the two films simultaneously to the laminator. Each mill line may have at least one press including working rolls arranged horizontally for pressing a powder mixture into a respective one of the films and at least one press including working rolls (typically arranged vertically) for reducing the thickness of the respective film. The apparatus may include a mill line expansion module that is insertable into a mill line and has at least one additional press including working rolls for reducing the thickness and controlling other key parameters of the respective film. Films may have elongation below 4% and tensile strength below 250 kPa.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### 1. Technical Field

The present disclosure relates generally to manufacturing energy storage devices such as Li-ion batteries and, more particularly, to dry processes for the manufacture of electrodes for energy storage devices.

### 2. Related Art

As demand for inexpensive energy storage devices increases, various methods have been proposed for manufacturing electrodes. Among these, there exist so-called “dry” processes by which a free-standing electrode film may be manufactured while avoiding the expense and drying time associated with the solvents and aqueous solutions that are typically used in slurry coating and extrusion processes. After a free-standing electrode film is produced, it is laminated to a current collector in order to produce an electrode. While there have been some attempts at devising a continuous process that both produces a free-standing electrode film and laminates the free-standing electrode film to a current collector (see, e.g., German Patent Application Pub. No. DE 10 2017 208 220), the success of such processes has been limited, in part due to the difficulty of producing a uniform electrode film and handling the free-standing electrode film without breaking it. The challenges are especially significant for thinner electrode films or for electrode films that are made to be less flexible from materials such as battery active materials, including, but not limited to, lithium nickel manganese cobalt oxide (NCM), lithium nickel cobalt aluminum oxide (NCA), lithium iron phosphate (LFP), graphite, and silicon, which can be more difficult to work with than activated carbon, for example.

### BRIEF SUMMARY

The present disclosure contemplates various apparatuses and methods, as well as related products, for overcoming the above drawbacks accompanying the related art. One aspect of the embodiments of the present disclosure is an apparatus for manufacturing an electrode for an energy storage device. The apparatus may comprise at least one laminator for simultaneously laminating two free-standing electrode films on opposite sides of a current collector and a pair of mill lines operable to produce, respectively, the two free-standing electrode films and to feed the two free-standing electrode films simultaneously to the laminator. Each of the mill lines may comprise at least one first press including working rolls arranged horizontally for pressing a powder mixture into a respective one of the free-standing electrode films and at least one second press including working rolls (typically arranged vertically) for reducing the thickness of the respective free-standing electrode film.

The apparatus may comprise a mill line expansion module. The mill line expansion module may be insertable into a mill line of the pair of mill lines and may comprise at least one additional second press including working rolls (typically arranged vertically) for reducing the thickness of the respective free-standing electrode film. In general, the number of presses may be directly related to the final electrode film thickness, porosity, and density and the corresponding film mechanical strength such as breakage elongation and tensile strength, as well as the speed of the mill lines. By employing a modular system rather than having a fixed number of presses, the apparatus can tailor these parameters for various material types with different electrode specifications.

Each of the mill lines may comprise one or more conveyors arranged to support the respective free-standing electrode film as it is fed from the at least one second press of the mill line to the laminator. The one or more conveyors may be arranged to support the respective free-standing electrode film as it is fed from a first of the at least one second press to a second of the at least one second press of the mill line. A speed of the one or more conveyors between the at least one second press of the mill line and the laminator may be controlled to be different from a speed of the one or more conveyors between the first of the at least one second press and the second of the at least one second press of the mill line. The one or more conveyors may be arranged to support the respective free-standing electrode film as it is fed from the at least one first press to the at least one second press of the mill line. The speeds of the conveyor(s) between each stage, including between the first press and the first of the second press(es), between any adjacent second press(es), and between the second press(es) and the laminator, may be controlled to be different. Each of the mill lines may comprise one or more tension sensors arranged to measure a tension of the free-standing electrode film. A speed of the one or more conveyors of the mill line and/or a speed of the working rolls of the at least one second press of the mill line may be controlled based on the measured tension, e.g., to prevent film breakage. The one or more conveyors may comprise at least one vacuum conveyor.

Another aspect of the embodiments of the present disclosure is a method of manufacturing an electrode for an energy storage device. The method may comprise providing the above apparatus, preparing a first powder mixture including an electrode active material and a fibrillizable binder, fibrillizing the fibrillizable binder in the first powder mixture by subjecting the first powder mixture to a shear force, pressing the first powder mixture into a first free-standing electrode film using the at least one first press of a first mill line of the pair of mill lines, reducing the thickness of the first free-standing electrode film using the at least one second press of the first mill line, and laminating the first free-standing electrode film on a first side of a current collector using the at least one laminator.

The method may comprise preparing a second powder mixture including an electrode active material and a fibrillizable binder, fibrillizing the fibrillizable binder in the second powder mixture by subjecting the second powder mixture to a shear force, pressing the second powder mixture into a second free-standing electrode film using the at least one first press of a second mill line of the pair of mill lines, reducing the thickness of the second free-standing electrode film using the at least one second press of the second mill line, and, simultaneously with said laminating the first free-standing electrode film on the first side of the current collector, laminating the second free-standing electrode film on a second side of the current collector opposite the first side using the at least one laminator.

Another aspect of the embodiments of the present disclosure is a method of manufacturing an electrode for an energy storage device. The method may comprise preparing a first powder mixture including an electrode active material and a fibrillizable binder, fibrillizing the fibrillizable binder in the first powder mixture by subjecting the first powder mixture to a shear force, preparing a second powder mixture including an electrode active material and a fibrillizable binder, fibrillizing the fibrillizable binder in the second powder mixture by subjecting the second powder mixture to a shear force, and simultaneously producing a first free-standing electrode film from the first powder mixture and a second free-standing electrode film from the second powder mixture using a pair of mill lines, each of the mill lines comprising at least one first press including working rolls arranged horizontally for pressing the respective powder mixture into the respective free-standing electrode film and at least one second press including working rolls (typically arranged vertically) for reducing the thickness of the respective free-standing electrode film. The method may further comprise, continuously with said producing the first and second free-standing electrode films, feeding the first and second free-standing electrode films from the respective mill lines to a laminator and laminating the first and second free-standing electrode films on opposite sides of a current collector.

The method may comprise supporting the first free-standing electrode film using one or more conveyors as the first free-standing electrode film is fed from the respective mill line to the laminator. The method may comprise supporting the first free-standing electrode film using the one or more conveyors as the first free-standing electrode film is fed from a first of the at least one second press to a second of the at least one second press of the respective mill line. The method may comprise controlling a speed of the one or more conveyors between the respective mill line and the laminator to be different from a speed of the one or more conveyors between the first of the at least one first press and the second of the at least one first press of the respective mill line. The method may comprise supporting the first free-standing electrode film using the one or more conveyors as the first free-standing electrode film is fed from the at least one first press to the at least one second press of the respective mill line. The method may comprise controlling the speeds of the conveyor(s) to be different between each stage, including between the first press and the first of the second press(es), between any adjacent second press(es), and between the second press(es) and the laminator. The method may comprise measuring a tension of the first free-standing electrode film and controlling a speed of the one or more conveyors and/or a speed of the working rolls of the at least one second press based on the measured tension, e.g., to prevent film breakage. The one or more conveyors may comprise at least one vacuum conveyor.

Another aspect of the embodiments of the present disclosure is a free-standing electrode film. The free-standing electrode film may comprise an electrode active material and a fibrillizable binder. A machine direction elongation percentage of the free-standing electrode film may be less than 4%. The machine direction elongation percentage of the free-standing electrode film may be less than 2%. A machine direction tensile strength of the free-standing electrode film may be greater than 450 kPa. The porosity of the free-standing electrode film may be less than 32%.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows an apparatus for manufacturing an electrode for an energy storage device;

FIG. 2 shows a partial view of the apparatus with a mill line expansion module being inserted into a mill line thereof;

FIG. 3 shows an operational flow for manufacturing an electrode for an energy storage device;

FIG. 4 shows an example sub-operational flow of step 330 in FIG. 3;

FIG. 5 shows active material loading as a function of film thickness for activated dry NCM811 electrodes; and

FIG. 6 shows C-rate performance of wet vs. activated dry NCM811 electrodes.

### DETAILED DESCRIPTION

The present disclosure encompasses various embodiments of apparatuses for manufacturing electrodes for energy storage devices as well as manufacturing methods and intermediate and final products thereof. The detailed description set forth below in connection with the appended drawings is intended as a description of several currently contemplated embodiments and is not intended to represent the only form in which the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

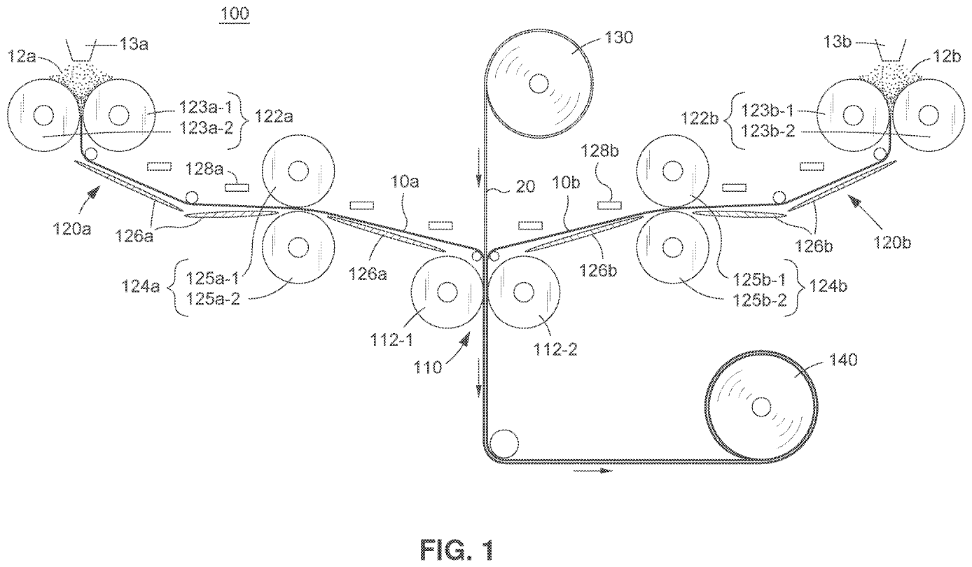

FIG. 1 shows an apparatus 100 for manufacturing an electrode for an energy storage device such as a Li-ion battery, solid state battery, Li-ion capacitor (LIC), or ultracapacitor. The finished energy storage device may comprise one or more electrodes assembled by laminating a first free-standing electrode film 10a and a second free-standing electrode film 10b on opposite sides of a current collector 20 such as an aluminum metal sheet in the case of cathode electrode film(s) 10a, 10b or a copper metal sheet in the case of anode electrode film(s) 10a, 10b. The apparatus 100 may comprise at least one laminator 110 for simultaneously laminating the two free-standing electrode films 10a, 10b on opposite sides of the current collector 20. The laminator 110 may have working rolls 112-1, 112-2 arranged horizontally as shown, for example, but a vertical arrangement is also contemplated. The apparatus 100 may further comprise a pair of mill lines 120a, 120b (e.g., arranged as wings of the apparatus 100) operable to produce, respectively, the two free-standing electrode films 10a, 10b and feed them simultaneously to the laminator 110. The laminator 110 may then laminate the two free-standing electrode films 10a, 10b on either side of the current collector 20 as it is unwound from a first spool 130 and subsequently wound, together with the laminated films 10a, 10b on a second spool 140 (or alternatively sent to a cutting machine). Owing to the apparatus 100 and associated methods described herein, efficient handling of the free-standing electrode films 10a, 10b may be possible, even in the case of relatively thin free-standing electrode films 10a, 10b (e.g., less than 200 μm or less than 100 μm) and/or those formed from less flexible materials (e.g., battery active materials) such as NCM, NCA, LFP, graphite, and silicon, allowing for the production of a wide variety of energy storage devices for different purposes. In some embodiments, as described in more detail below, the apparatus 100 may have a modular design, allowing the same apparatus 100 to be used to efficiently manufacture electrodes for energy storage devices having different specifications as needed.

Depending on the particular application of the energy storage device to be manufactured, the dry powder mixtures 12a, 12b used to produce the free-standing electrode films 10a, 10b may have various formulations and may be produced according to various methods. Some exemplary dry powder formulations and methods that may be used to produce the dry powder mixtures 12a, 12b are described in the inventor's own patents and patent applications, including U.S. Pat. No. 10,069,131, entitled “Electrode for Energy Storage Devices and Method of Making Same,” U.S. Patent Application Pub. No. 2020/0388822, entitled “Dry Electrode Manufacture by Temperature Activation Method,” U.S. Patent Application Pub. No. 2022/0077453, entitled “Dry Electrode Manufacture with Lubricated Active Material Mixture,” U.S. patent application Ser. No. 17/097,200, entitled “Dry Electrode Manufacture with Composite Binder,” and U.S. patent application Ser. No. 17/492,458, entitled “Dry Electrode Manufacture for Solid State Energy Storage Devices,” the entire disclosure of each of which is wholly incorporated by reference herein. Typically, since the first and second free-standing electrode films 10a, 10b will be disposed by the apparatus 100 on the same current collector 20, both dry powder mixtures 12a, 12b will be formulated and produced in the same way (and thus in practice may be divided from the same production batch, for example).

Each of the mill lines 120a, 120b may comprise at least one first press 122a, 122b for pressing one of the powder mixtures 12a, 12b into a respective free-standing electrode film 10a, 10b. Referring to the mill line 120a by way of example (equivalent reference numbers using the letter “b” instead of “a” in the case of the mill line 120b), the first press 122a may include working rolls 123a-1, 123a-2 arranged horizontally as shown, such that the powder mixture 12a may be poured on top of the working rolls 123a-1, 123a-2 (from a powder feed conveyor 13a, for example) and emerge from the bottom thereof in the form of a continuous film having been subjected to pressure and heat by the working rolls 123a-1, 123a-2. To this end, the working rolls 123a-1, 123a-2 of the first press 122a may have elevated surface temperatures (e.g., greater than 70 °C). Advantageously, the working rolls 123a-1, 123a-2 may be controlled to rotate at the same speed as each other, with the gap between the working rolls 123a-1, 123a-2 being freely adjustable to affect the film density and porosity as desired for the particular material and application. In this regard, it is noted that it may be unnecessary for the first press 122a to produce a shear effect by the operation of working rolls 123a-1, 123a-2 having different speeds, especially in a case where the powder mixture 12a has been produced by one of the exemplary methodologies referred to above in which the powder mixture 12a has already been subjected to a shear force using a jet mill, for example.

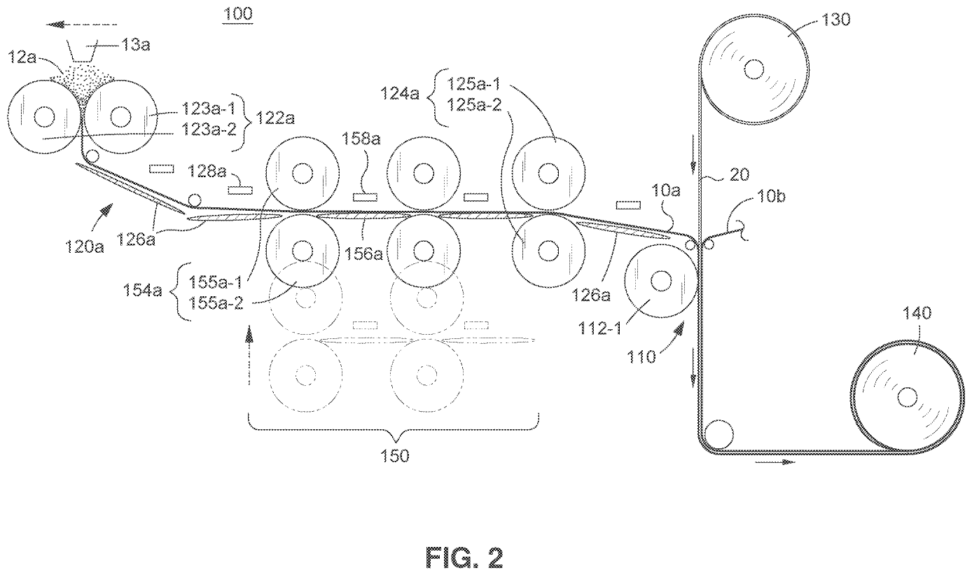

Each of the mill lines 120a, 120b may further comprise at least one second press 124a, 124b for reducing the thickness of the respective free-standing electrode film 10a, 10b. Referring again to the mill line 120a by way of example, the second press 124a may include working rolls 125a-1, 125a-2 that are typically (though not necessarily) arranged vertically as shown. Like the working rolls 123a-1, 123a-2 of the first press 122a, the working rolls 125a-1, 125a-2 of the second press 124a may have elevated surface temperatures (e.g., greater than 70 °C) and may be controlled to rotate at the same speed as each other, with the gap between the working rolls 125a-1, 125a-2 being freely adjustable as desired. While only a single second press 124a is shown in FIG. 1, it is contemplated that any number of second presses 124a may be provided in a row, each one further reducing the thickness of the free-standing electrode film 10a through the application of heat and pressure (e.g., with the working rolls 125a-1, 125a-2 in contact with the film 10a and the gap between the working rolls 125a-1, 125a-2 successively becoming smaller for each second press 124a) until the desired film thickness is achieved for the given application. As described in more detail below in relation to the modular aspects of the apparatus 100, it may be most advantageous for each mill line 120a, 120b to include only a single second press 124a, 124b as part of the base construction of the apparatus 100 (with the apparatus 100 being expandable using one or more mill line expansion modules 150 as shown in FIG. 2) in order to best accommodate production runs that use only a single second press 124a, 124b in each mill line 120a, 120b, such as when producing relatively thick free-standing electrode films 10a, 10b. Along the same lines, it is contemplated that the base construction of each mill line 120a, 120b may include only the one or more first presses 122a, 122b, without any second presses 124a, 124b whatsoever in some implementations.

As newer energy storage device applications begin to require electrodes made from thinner free-standing electrode films 10a, 10b, and as the possibilities for active materials grow to encompass materials that produce less flexible and more breakable free-standing electrode films 10a, 10b, conventional roll-to-roll processing apparatuses and methods may be inadequate for handling the free-standing electrode films 10a, 10b without breakage. Therefore, in order to better support each free-standing electrode film 10a, 10b as it passes through the respective mill line 120a, 120b toward the laminator 110 (after which the free-standing electrode film 10a, 10b will be adequately supported by the sturdier current collector 20 and will no longer be free-standing), it is contemplated that each mill line 120a, 120b may comprise one or more conveyors 126a, 126b such as vacuum conveyors, for example. Referring to the mill line 120a by way of example, the one or more conveyors 126a may be arranged to support the free-standing electrode film 10a at any of various positions including, for example, i) as the free-standing electrode film 10a is fed from the second press(es) 124a of the mill line 120a to the laminator 110, ii) as the free-standing electrode film 10a is fed from a first of the second press(es) 124a to a second of the second press(es) 124a, and/or iii) as the free-standing electrode film 10a is fed from the first press(es) 122a to the second press(es) 124a. The speed of each conveyor 126a may be controlled in accordance with the thickness and tension of the free-standing electrode film 10a at each particular position, which may be determined by the arrangement of the presses 122a, 124a and roller speeds thereof, as well as that of the downstream laminator 110. For example, the speed(s) of the conveyor(s) 126a between the second press(es) 124a and the laminator 110 may be controlled to be different from the speed(s) of the conveyor(s) between successive second press(es) 124a, which may in turn be different from the speed(s) of the conveyor(s) between the first press(es) 122a and the second press(es) 124a. In practice, the speeds of the conveyor(s) 126a may be controlled in a cascading fashion, with a final laminator speed 110 determining the speeds at each upstream position of each mill line 120a, 120b. As feedback to the control process, each mill line 120a, 120b may comprise one or more tension sensors 128a, 128b arranged to measure a tension on the free-standing electrode film 10a, 10b. Load cells or other proximity sensors may be employed to maintain the optimum tension control by adjusting the conveyor and working roll rotation speeds. The variable speed(s) and/or speed ratio(s) of the one or more conveyor(s) 126a, 126b may be controlled so that speed(s) between presses are appropriately matched based on the measured tension(s) using any of various algorithms including machine learning models, allowing the lamination speed to remain constant and preventing rupture of the films 10a, 10b.

FIG. 2 shows a partial view of the apparatus 100 with a mill line expansion module 150 being inserted into a mill line 120a thereof. The mill line expansion module 150 may comprise at least one additional second press 154a for reducing the thickness of the respective free-standing electrode film 10a, 10b (in this case the electrode film 10a as illustrated). As shown, for example, the mill line 120a of the base apparatus 100 may include a single second press 124a and the mill line expansion module 150 may introduce one or more additional second presses 154a (two additional second presses 154a as illustrated). The additional second press(es) 154a may be insertable into the mill line 120a just prior to the second press 124a of the base apparatus 100, for example. (It is noted that, in a case where the mill line 120a includes no second presses 124a, the additional second press(es) 154a introduced by the mill line expansion module 150 may be the only thickness-reducing presses of the apparatus 100.) The dashed arrows in FIG. 2 show one possible insertion procedure in which the first press 122a is moved farther away from the laminator 110 (toward the left in FIG. 2) and the mill line expansion module 150 is slotted into the space created thereby (upward in FIG. 2), with phantom lines illustrating the mill line expansion module 150 prior to being inserted into the mill line 120a.

Like each second press 124a, 124b of the respective mill lines 120a of the base apparatus 100, each additional second press 154a introduced by a mill line expansion module 150 may include working rolls 155a-1, 155a-2 that are typically (though not necessarily) arranged vertically as shown. The working rolls 155a-1, 155a-2 of each additional second press 154a may have elevated surface temperatures (e.g., greater than 70 °C) and may be controlled to rotate at the same speed as each other, with the gap between the working rolls 155a-1, 155a-2 being freely adjustable as desired. It is contemplated that the mill line expansion module 150 may further include one or more additional conveyors 156a that are insertable between conveyors 126a of the mill line 120a as shown. The mill line expansion module 150 may further include one or more additional tension sensors 158a that are arranged to measure a tension on the free-standing electrode film 10a as it passes through (e.g., before or after) the additional second press(es) 154a of the mill line expansion module 150. The additional conveyor(s) 156a and additional tension sensor(s) 158a may be connected to the same speed control system as the conveyor(s) 126a and tension sensor(s) 128a of the base apparatus 100. It is noted that the mill line expansion module 150 may be symmetrically designed for insertion in the mill line 120b rather than the mill line 120a as illustrated (and equivalent reference numbers using the letter “b” instead of “a” may be referred to in this case, though not separately illustrated).

By virtue of the mill line expansion module 150, the same apparatus 100 may be readily customizable for different production runs having different specifications for the energy storage device to be produced. A manufacturer of energy storage devices that are made using relatively thick free-standing electrode films 10a, 10b may use only the base apparatus 100 with no mill line expansion modules 150 or with only a single mill line expansion module 150 in each mill line 120a, 120b, while a manufacturer who needs to produce thinner free-standing electrode films 10a, 10b may insert several mill line expansion modules 150 (or, in some cases, mill line expansion modules 150 having a greater number of additional second presses 154a, 154b, though a standardized mill line expansion module 150 may be preferable). The same apparatus 100 can satisfy the needs of both manufacturers, allowing for the efficient production and use of the apparatus 100 and mill line expansion modules 150. Without the modular design, it would be necessary either i) to market and produce a variety of different size apparatuses 100 or to custom-build the apparatus 100 for each manufacturer (with associated inefficiencies and costs in either case) or ii) to produce only the largest possible apparatus 100 with the highest possible number of second presses 124a, 124b that might be used. In the latter case, the apparatus 100 may become unreasonably expensive for a manufacturer who does not need to reduce the thickness of the free-standing electrode film 10a, 10b so much, both in terms of the purchase price but also in terms of maintenance and required personnel to oversee and run such a large apparatus 100. Moreover, any unused second presses 124a, 124b in a given run increase the risk of damaging the free-standing electrode film 10a, 10b as it is en route to the laminator 110, decreasing the yield of the run and making a large number of unused second presses 124a, 124b a liability for the manufacturer.

Along the same lines, a manufacturer who produces a variety of different products is better served by the modular apparatus 100, which may allow the manufacturer to increase or decrease the number of presses as need by attaching or detaching mill line expansion modules 150. The apparatus 100 may be used for some runs with several mill line expansion modules 150 and for other runs with few or none, decreasing the associated costs of these runs in terms of personnel and yield. As another possibility, it is contemplated that a mill line expansion module 150 may be used as a replacement in the event that the press(es) 154a, 154b of another mill line expansion module 150 need repair. Rather than shut down the entire manufacturing line pending the repair of the damaged press stations, the mill line expansion module 150 where the problem is occurring can simply be swapped for a fresh mill line expansion module 150. In this way, the manufacturing process can continue after only a moment's delay. The damaged mill line expansion module 150 can be repaired, without significantly interrupting production, even as the manufacturing process is ongoing.

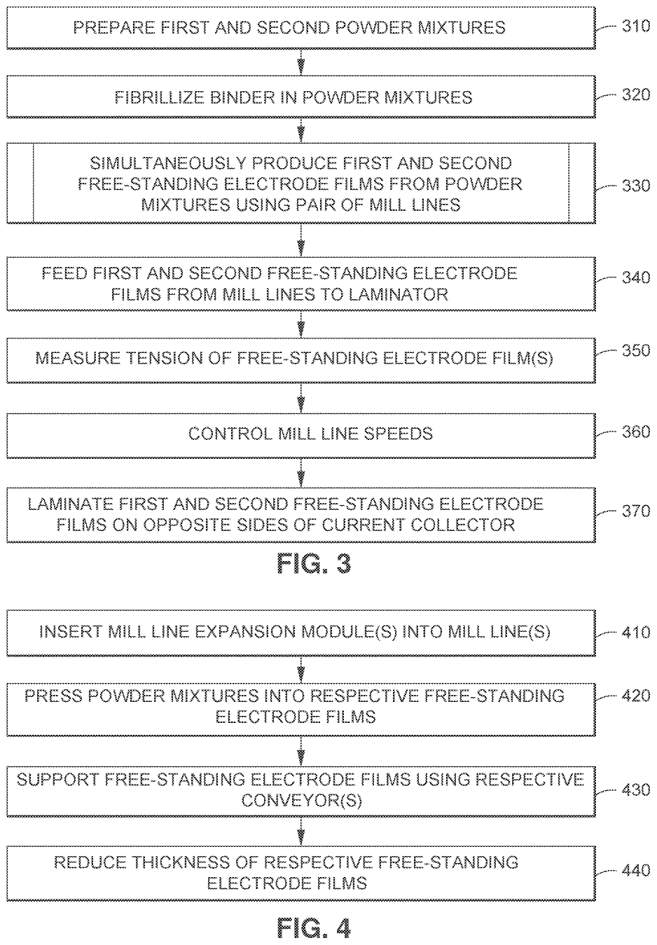

FIG. 3 shows an operational flow for manufacturing an electrode for an energy storage device in accordance with the disclosed innovations. In particular, the operational flow of FIG. 3 may be performed using the apparatus 100 described in relation to FIGS. 1 and 2. The operational flow may begin with preparing first and second power mixtures 12a, 12b (step 310) and fibrillizing a binder contained in the powder mixtures 12a, 12b (step 320). For example, as described in the inventor's own patents and patent applications, incorporated by reference above, the powder mixture 12a, 12b may include, in addition to at least one type of electrode active material (e.g. a lithium metal oxide in the case of a cathode or graphite or silicon in the case of an anode), at least one type of fibrillizable binder such as such as polytetrafluoroethylne (PTFE), polyvinylpyrrolidone (PVP), polyvinylidene fluoride (PVDF), polyethylene oxide (PEO), polyethylene (PE), or carboxymethylcellulose (CMC), or a combination of the above binders or co-polymers. Fibrillizable binders may be characterized by their soft, pliable consistency and, in particular, by their ability to stretch, becoming longer and finer to take on a fibrous status when they undergo shear force. Owing to the use of one or more fibrillizable binders, which may further be chemically or thermally activated to increase its flexibility as described in the inventor's patents and patent applications, the powder mixture may be pressed into a free-standing film without breakage and without excessive use of toxic and expensive solvents such as N-Methylpyrrolidone (NMP). The binder may be fibrillized by subjecting the powder mixture 12a, 12b to a shear force, e.g., using a kitchen blender, industrial blender, coffee grinder, grain mill grinder, high speed mixer, cyclone paint mixer, rotary mixer, planetary mixer, high shear disperser such as Admix Rotosolver, high shear granulator such as Diosna P1-6, high shear micronizer such as a jet mill, high shear emulsifier, high shear mixer such as Ross Megashear mixer, or acoustical mixer. As noted above, the powder mixtures 12a, 12b may in practice be divided from the same production batch. In this regard, it should be noted that steps 310 and 320 may be combined, or, equivalently, step 310 may encompass preparing the first and second powder mixtures 12a, 12b without separating them (i.e., preparing enough powder mixture for two mill lines 120a, 120b).

The operational flow of FIG. 4 may continue with simultaneously producing first and second free-standing electrode films 10a, 10b from the powder mixtures 12a, 12b using a pair of mill lines 120a, 120b such as those described in relation to FIGS. 1 and 2 (step 330). FIG. 4 shows an example sub-operational flow of this step, which may begin with inserting one or more mill line expansion modules 150 into the mill lines 120a, 120b as needed to achieve the particular specifications (e.g., thickness, density and porosity, and mechanical strength, such as film tensile strength and elongation) of each free-standing electrode film 10a, 10b for the electrode to be manufactured (step 410). With the mill lines 120a, 120b of the apparatus 100 having been expanded accordingly, the sub-operational flow of FIG. 4 may proceed with pressing the powder mixtures 12a, 12b into respective free-standing electrode films 10a, 10b using respective first presses 122a, 122b (step 420), supporting the free-standing electrode films 10a, 10b as they pass through the mill lines 120a, 120b using conveyors 126a, 126b (step 430), and reducing the thicknesses of the respective free-standing electrode films 10a, 10b using any second press(es) 124a, 124b that are part of the base apparatus 100 plus any additional second press(es) 154a, 154b that are added by mill line expansion modules 150 (step 440). Owing to the innovative design of the apparatus 100, the two free-standing electrode films 10a, 10b may be produced and appropriately thinned simultaneously, allowing for the subsequent feeding to the laminator 110 and simultaneous lamination on the current collector 20.

In particular, referring back to FIG. 3, the operational flow may proceed with feeding the first and second free-standing electrode films 10a, 10b from the respective mill lines 120a, 120b to the laminator 110 (step 340). Of particular note, this may be done while continuing to support the free-standing electrode films 10a, 10b on appropriately speed-controlled conveyors 126a, 126b, thus minimizing the possibility of breakage at a position where the films 10a, 10b are at their thinnest, lowest break strength, or most fragile. In this regard, the operational flow may further include measuring the tension of each free-standing electrode film 10a, 10b at one or more positions using tension sensors 128a, 128b, 158a, 158b (step 350) and controlling the mill line speeds accordingly as described above, in particular, by adjusting the speeds of conveyors 126a, 126b, 156a, 156b (step 360) and/or the rotation speed(s) of the working rolls. As the free-standing electrode films 10a, 10b exit the respective mill lines 120a, 120b, the laminator 110 may laminate them on opposite sides of the current collector 20 (step 370), which may in some cases be pre-treated with chemical etching, coated with a conductive binder layer, or both. The finished electrode may be wound on the second spool 140 or cut by a cutting machine. By simultaneously producing the free-standing electrode films 10a, 10b using the pair of mill lines 120a, 120b and feeding the free-standing electrode films 10a, 10b to the laminator 110 in a continuous process (especially where the mill lines 120a, 120b are arranged as upstream wings of a distinct central press serving as the laminator 110), the disclosed manufacturing process may proceed at more than double the speed of processes that use the same single mill line to produce both films. In such processes, a separate laminator machine must be loaded with two rolls of the produced active material film and one roll of current collector between formation of the films and lamination on the current collector, such that the final electrode lamination speed is at most half of the mill line speed. The disclosed apparatus 100 is capable of twice the speed of such multi-step processes.

Exemplary data of free-standing electrode films 10a, 10b made from three different active materials is provided in Table 1, below.

TABLE 1

| | | | | Avg. | Avg. | | Avg. | Avg. |
|---|---|---|---|---|---|---|---|---|
| | Film | Number | Avg. | Peak | Tensile | Avg. | Film | Film |
| | Group | of | Thickness | Force | Strength | Elongation | Density | Porosity |
| | (μm) | Presses | (μm) | (gf) | (kPa) | (%) | (g/cc) | (%) |
| NCM | 65 | 15 | 67 | 102.7 | 600.3 | 0.50% | 3.40 | 25.9 |
| Cathode | 80 | 12 | 84 | 128.3 | 596.1 | 0.69% | 3.30 | 28.0 |
| | 100 | 10 | 105 | 157.3 | 590.3 | 0.85% | 3.20 | 30.2 |
| | 110 | 9 | 115 | 164.3 | 560.0 | 1.33% | 3.18 | 30.7 |
| | 150 | 4 | 154 | 191.5 | 488.8 | 1.85% | 3.11 | 32.2 |
| | 180 | 3 | 186 | 222.3 | 469.5 | 1.98% | 3.06 | 33.4 |
| | 200 | 2 | 206 | 219.0 | 418.1 | 2.04% | 3.03 | 34.0 |
| | 250 | 1 | 252 | 173.0 | 268.8 | 2.59% | 3.02 | 34.2 |
| Graphite | 65 | 2 | 65 | 188.7 | 1144.7 | 0.20% | 1.71 | 23.5 |
| Anode | 80 | 2 | 85 | 128.0 | 589.9 | 0.60% | 1.60 | 28.6 |
| | 100 | 2 | 104 | 85.0 | 321.0 | 0.74% | 1.44 | 35.8 |
| | 110 | 2 | 113 | 76.7 | 266.4 | 1.03% | 1.39 | 37.8 |
| | 150 | 1 | 154 | 99.3 | 252.3 | 1.05% | 1.27 | 42.9 |
| | 200 | 1 | 202 | 47.0 | 91.3 | 1.11% | 1.24 | 44.6 |
| | 250 | 1 | 250 | 34.0 | 53.4 | 1.27% | 1.23 | 45.3 |
| | 300 | 1 | 306 | 36.0 | 46.2 | 1.40% | 1.21 | 46.0 |
| Activated | 80 | 3 | 87 | 92.7 | 418.3 | 4.49% | — | — |
| Carbon | 100 | 3 | 110 | 107.0 | 382.3 | 4.86% | — | — |
| Cathode | 110 | 3 | 118 | 105.7 | 350.3 | 6.68% | — | — |
| or Anode | 150 | 3 | 155 | 112.7 | 284.5 | 7.38% | — | — |

To produce each film group to the specified thickness (“Film Group” column), the disclosed apparatus 100 may be equipped with a suitable number of presses (“Number of Presses” column). In this regard, the number of presses shown in Table 1 (ranging from 1 to 15 for this data) should be understood to refer to all presses in a given mill line 120a, including both first press(es) 122a and second press(es) 124a, as well as any additional second press(es) 154a added using one or more mill line expansion modules 150. For example, the 250 μm NCM cathode film group (Number of Presses=1) may be produced using an apparatus 100 having a single first press 122a and no second press 124a in the mill line 120a used to produce the film, whereas the 65 μm NCM cathode film group (Number of Presses=15) may be produced with the same apparatus 100 having a single first press 122a in the mill line 120a but with fourteen additional second press(es) 154a added by mill line expansion modules 150. Table 1 shows an average thickness (“Avg. Thickness” column) that is exemplary of actual measured thicknesses corresponding to each film group in practice.

The last five columns of Table 1 show exemplary data of such films, where it can be seen that the tensile strength and film density of the film increases for thinner films and varies for different materials, while the elongation percentage (maximum machine direction elongation before breakage) and film porosity decreases for thinner films and likewise varies from material to material. The elongation percentage may be determined by a pull test (where the machine direction may refer to a draw direction in which the film is elongated by operation of the working rolls). An exemplary pull test may measure the distance pulled before breakage of a 2.5 cm wide by 10 cm long (machine direction) strip of film at an initial tension of 5 gf, for example. In particular, it is noted that the NCM cathode and graphite anode films are more difficult to work with than activated carbon films, owing to their being significantly less flexible (and thus having lower elongation percentages). As can be seen, the difficulty becomes even more pronounced for thinner films. By virtue of the apparatus 100 and associated processes described herein, it is contemplated that a wide variety of free-standing electrode films 10a, 10b can be successfully and efficiently produced on the same apparatus 100. For example, free-standing electrode films 10a, 10b may be made of various materials including NCM, graphite, or activated carbon and may have thicknesses ranging from upwards of 300 μm down to as little as 50 μm or thinner. For each run of the apparatus 100, the mill lines 120a, 120b may be outfitted accordingly for the desired thickness or other parameters, expanded as needed by inserting mill line expansion modules 150 to increase the number of thickness-reducing presses. Moreover, owing to the innovative design of the apparatus 100, preferably including the conveyor(s) 126a, 126b, 156a, 156b to support the fragile films 10a, 10b as they pass through the mill lines 120a, 120b prior to being laminated on the current collector 20, it is contemplated that the resulting free-standing electrode films 10a, 10b may have tensile strengths ranging from 40 kPa up to greater than 100 kPa, greater than 450 kPa or even greater than 600 kPa (in the case of NCM or graphite) or, for very thin graphite anode films greater than 1100 kPa. At the same time, the machine direction elongation percentage may range from 10% down to less than 4% or even less than 2%, sometimes being as low as 0.50% or even 0.20% (in the case of NCM or graphite). The efficient handling of such fragile free-standing electrode films 10a, 10b would not be achievable without the disclosed innovations of the apparatus 100 and associated processes.

In general, it is contemplated that free-standing films having tensile strength of higher than 100 kPa and elongation percentage of less than 10% along the machine direction may require unique tension control designs to achieve high speed production processes. The use of the contemplated conveyors 126a, 126b, 156a, 156b combined with strategically placed sensors 128a, 128b (sometimes using multiple measurement methods) along the free-standing film axis may provide the necessary control to handle sensitive battery active material electrode films 10a, 10b. The difficulty in producing dry battery electrode in a free-standing film comes from the inherent brittle nature of the active materials that make conventional web handling methods impossible. By using conveyors 126a, 126b, 156a, 156b to support and transport the free-standing electrode film 10a, 10b through each press station in an automated self-threading process, the disclosed apparatus 100 and methods may overcome these difficulties.

Advantageously, the multiple press design of the apparatus 100 may allow for greater flexibility in tailoring the final electrode properties such as thickness uniformity, density, and porosity compared to other dry process electrodes produced with or without free-standing films. As shown in Table 1 above, by way of example, the film density may be selected as desired (e.g., between 3.02 g/cc and 3.40 g/cc for an NCM cathode or between 1.21 g/cc and 1.71 g/cc for a graphite anode) and likewise the film porosity may be selected as desired (e.g., between 25.9% and 34.2% for an NCM cathode or between 23.5% and 46.0% for a graphite anode), with low porosities (e.g., less than 32%) being achievable owing to the efficient handling of fragile free-standing electrode films 10a, 10b using the apparatus 100. In general, dry battery electrode technology requires the ability to control the loading, porosity, and uniformity of the active material layer. Other dry battery electrode processing techniques are not capable of precise tailored control of these parameters. For example, a dry spray or dry deposition electrode process that does not produce a free-standing film may be limited in the ability to control the thickness uniformity as the powder is sitting on top of the current collector and is unable to flow in multiple axes during the press. Additionally, the density and porosity may be limited by the amount of powder that can be applied to the current collector prior to pressing and the limitation of the pressing force that can be used without damaging the current collector. The disclosed innovations, by using multiple pressing stations working in tandem to produce free-standing electrode films 10a, 10b for both sides of the current collector 20 simultaneously can address all these requirements. Furthermore, having the system's thickness-reducing press stations in a modular configuration (employing a freely insertable mill line expansion module 150), rather than a fixed number of presses, allows for customization based on different material types such as anode materials or custom cathode materials.

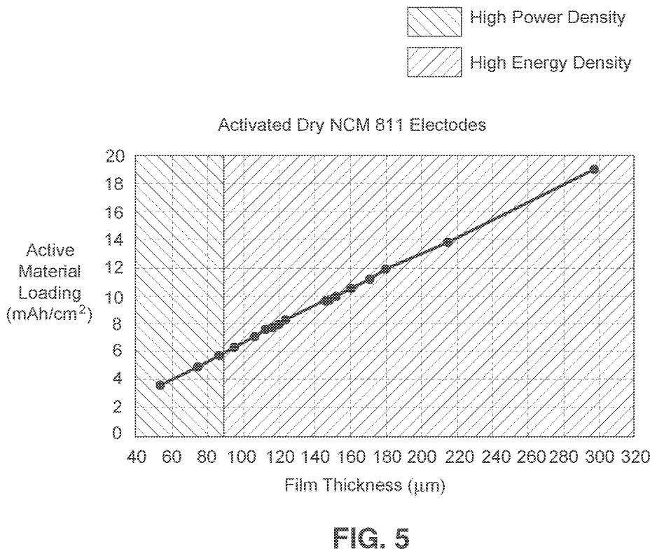

FIG. 5 shows active material loading as a function of film thickness for activated dry NCM811 electrodes (having a nickel:cobalt:manganese ratio of 8:1:1). As illustrated, the degree of active material loading, represented as discharge capacity per unit area (mAh/cm²), may be determined, at least in part, by the film thickness (μm). Electrodes made from thinner films (e.g., below 90 μm) may exhibit discharge capacity per unit area of less than 6 mAh/cm², for example, which may typically be suitable as a drop-in technology for high power density application such as electric vehicles (EV). Meanwhile, electrodes made from thicker films (e.g., above 80 μm) may exhibit discharge capacity per unit area of greater than 6 mAh/cm², for example, which may typically be suitable for high energy density applications such as energy storage systems (ESS). Using conventional methods, such wide-ranging applications require different manufacturing equipment that is specialized for each application, resulting in great cost and inefficiency to the manufacturer. In contrast, embodiments of the apparatus 100 described herein may advantageously allow a wide variety of electrodes to be produced using the same apparatus 100, with the thicknesses of the free-standing films 10a, 10b and other parameters being freely selectable by modifying the number of thickness-reducing presses 124a, 124b, 154a, 154b using mill line expansion modules 150, for example, allowing for the manufacture of batteries for EV, ESS, and other applications at relatively low cost and with great efficiency.

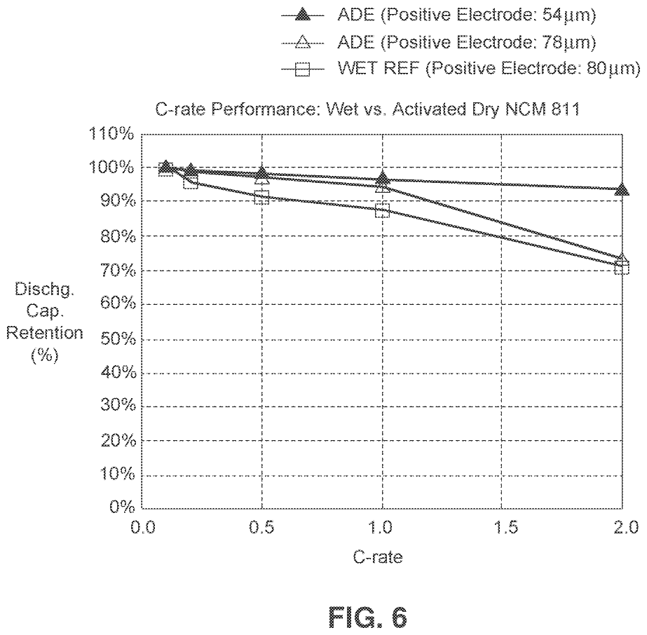

FIG. 6 shows C-rate performance of wet vs. activated dry NCM811 electrodes (ADE). Activated dry electrodes may refer to those produced by activated dry methods as described herein and incorporated by reference, for example, whereas contemplated wet electrodes (WET REF) may be made by conventional slurry coating methods, for example. As can be seen, the performance of an electrode at a given C-rate, represented as discharge capacity retention (%), may depend on the thickness of the activated dry electrode film, with thinner ADE films (e.g., 54 μm) exhibiting better performance at higher C-rates than thicker ADE films (e.g., 78 μm) or wet electrodes. Thus, depending on the desired C-rate of the battery to be produced, a manufacturer may wish to be able to freely adjust the thickness of the electrode film, something that is not easy to do and often not possible using conventional manufacturing equipment. By virtue of embodiments of the apparatus 100 described herein, however, the thicknesses of the free-standing films 10a, 10b may be customizable as needed for the desired C-rate or other parameter of the energy storage device to be produced.

In the above examples, it is described how the apparatus 100 may be used to produce a double-sided electrode by simultaneously running both mill lines 120a, 120b and laminating two free-standing electrode films 10a, 10b on opposite sides of a current collector 20. However, the processes described herein are not intended to be limited to the use of the apparatus 100 in this way. For example, in order to produce a single-sided electrode, a single mill line 120a of the apparatus 100 may be run, with the laminator 110 laminating only a single free-standing electrode film 10a on the current collector 20. It should also be recognized that any of the working rolls 112-1, 112-2 of the laminator 110, the working rolls 123a-1, 123a-2, 125a-1, 125a-2 of the mill line 120a, the working rolls 155a-1, 155a-2 of the mill line expansion module 150, and any corresponding working rolls provided in relation to the mill line 120b may be supported by one or more backing rolls such as a 4HI, 6HI, or cluster roll configuration.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

1-12. (canceled)

13. A method of manufacturing an electrode for an energy storage device, the method comprising:
preparing a first powder mixture including an electrode active material and a fibrillizable binder;
fibrillizing the fibrillizable binder in the first powder mixture by subjecting the first powder mixture to a shear force;
preparing a second powder mixture including an electrode active material and a fibrillizable binder;
fibrillizing the fibrillizable binder in the second powder mixture by subjecting the second powder mixture to a shear force;
simultaneously producing a first free-standing electrode film from the first powder mixture and a second free-standing electrode film from the second powder mixture using a pair of mill lines, each of the mill lines comprising at least one first press including working rolls arranged horizontally for pressing the respective powder mixture into the respective free-standing electrode film and at least one second press including working rolls for reducing the thickness of the respective free-standing electrode film; and,
continuously with said producing the first free-standing electrode film and the second free-standing electrode film, feeding the first free-standing electrode film and the second free-standing electrode film from the respective mill lines to a laminator and laminating the first free-standing electrode film and the second free-standing electrode film on opposite sides of a current collector.

14. The method of claim 13, further comprising supporting the first free-standing electrode film using one or more conveyors as the first free-standing electrode film is fed from the respective mill line to the laminator.

15. The method of claim 14, further comprising supporting the first free-standing electrode film using the one or more conveyors as the first free-standing electrode film is fed from a first of the at least one second press to a second of the at least one second press of the respective mill line.

16. The method of claim 15, further comprising controlling a speed of the one or more conveyors between the respective mill line and the laminator to be different from a speed of the one or more conveyors between the first of the at least one first press and the second of the at least one first press of the respective mill line.

17. The method of claim 15, further comprising supporting the first free-standing electrode film using the one or more conveyors as the first free-standing electrode film is fed from the at least one first press to the at least one second press of the respective mill line.

18. The method of claim 14, further comprising measuring a tension of the first free-standing electrode film and controlling a speed of the one or more conveyors based on the measured tension.

19. The method of claim 18, further comprising controlling a speed of the working rolls of the at least one second press based on the measured tension.

20. The method of claim 14, wherein the one or more conveyors comprises at least one vacuum conveyor.

21. The method of claim 13, wherein the working rolls of the at least one second press are arranged vertically.

22. A free-standing electrode film comprising:
an electrode active material; and
a fibrillizable binder,
wherein a machine direction elongation percentage of the free-standing electrode film is less than 2%.

23. (canceled)

24. The free-standing electrode film of claim 22, wherein a machine direction tensile strength of the free-standing electrode film is greater than 100 kPa.

25. The free-standing electrode film of claim 22, wherein the porosity of the free-standing electrode film is less than 32%.

26. A free-standing electrode film comprising:
an electrode active material; and
a fibrillizable binder,
wherein the porosity of the free-standing electrode film is less than 32%.
